(19) United States
(12) Patent Application Publication
(10) Pub. No.: US 2019/0322446 A1
(43) Pub. Date: Oct. 24, 2019

(54) BREWING CAPSULE FOR BREWED BEVERAGES

(71) Applicant: Two Beans in a Pod LLC, Bay Springs, MS (US)

(72) Inventor: Kimberly Alexandra Brown, Bay Springs, MS (US)

(21) Appl. No.: 16/391,949

(22) Filed: Apr. 23, 2019

Related U.S. Application Data
(60) Provisional application No. 62/661,625, filed on Apr. 23, 2018.

(51) Int. Cl. B65D 85/804; A47J 31/40

(52) U.S. Cl. CPC B65D 85/8043; A47J 31/407

(57) ABSTRACT

This disclosure relates to brewing capsules designed to create less waste in so called “single-server brewing machines”. In one embodiment, a brewing capsule includes a capsule brewing receptacle defining a receptacle brewing cavity and a first receptacle opening, a receptacle divider, and a capsule cover. The capsule cover is configured to be pierceable by an inlet brewing needle and covers the first receptacle opening. The receptacle divider is configured to divide the receptacle brewing cavity into a first brewing compartment and a second brewing compartment. As such, the first brewing compartment and the second brewing compartment are partitioned by the receptacle divider. In this manner, organic brewing material can be placed in both of the brewing compartments so that the brewing capsule can be used more than once to brew a beverage. By allowing for multiple uses, the configuration of the brewing capsule reduces the production of waste.

### RELATED APPLICATIONS

This application claims the benefit of provisional patent application Ser. No. 62/661,625, filed Apr. 23, 2018, the disclosure of which is hereby incorporated herein by reference in its entirety.

### FIELD OF THE DISCLOSURE

This disclosure relates generally to a brewing capsule for brewing beverages.

### BACKGROUND

Brewing machines that utilize brewing capsules have become more and more popular in recent years due to their convenience and ability to make high quality brewed beverages. In general, these brewing machines work by placing a brewing capsule into a chamber housing of the brewing machine. The brewing capsule is filled with organic material that is placed over a filter in the bottom of the brewing capsule to brew a beverage, such as coffee, tea, etc. A chamber housing lid is then lowered onto the chamber housing. The chamber housing lid has an inlet brewing needle that pierces the top of the brewing capsule while an outlet brewing needle at the bottom of the chamber housing pierces the bottom of the brewing capsule. During the brewing process, hot water is provided through the inlet brewing needle into the brewing capsule to brew the beverage. The brewed beverage then filters through the brewing filter and into the outlet brewing needle so that the brewed beverage is routed into a beverage container, such as a coffee cup.

Using these brewing machines is advantageous due to their convenience. A user need only brew one cup at a time. The cup is brewed quickly and at a more ideal temperature and pressure compared to most conventional coffee makers. However, the problem with these systems is that these brewing machines generate an enormous amount of waste. These brewing machines have in general been termed “single-serve” brewing machines, since every time a user makes a cup of coffee a brewing capsule is consumed. It is estimated that each year the brewing capsules consumed by these brewing machines could circle the earth twelve times.

Thus, what is needed are systems and techniques of utilizing these brewing machines without generating so much waste.

### SUMMARY

This disclosure relates to brewing capsules that are designed to create less waste. In one embodiment, a brewing capsule includes a capsule brewing receptacle defining a receptacle brewing cavity and a first receptacle opening, a receptacle divider, and a capsule cover. The capsule cover is configured to be pierceable by an inlet brewing needle and covers the first receptacle opening. The receptacle divider is configured to divide the receptacle brewing cavity into a first brewing compartment and a second brewing compartment. As such, the first brewing compartment and the second brewing compartment are partitioned by the receptacle divider. In this manner, organic brewing material can be placed in both of the brewing compartments so that the brewing capsule can be used more than once to brew a beverage. By allowing for multiple uses, the configuration of the brewing capsule reduces the production of waste.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWINGS

The accompanying drawings incorporated in and forming a part of this specification illustrate several aspects of the disclosure, and together with the description serve to explain the principles of the disclosure.

FIG. 1 illustrates a perspective view of one embodiment of a brewing capsule.

FIG. 2 illustrates a cross sectional view of the brewing capsule shown in FIG. 1.

FIG. 3 illustrates a cut and perspective view of the brewing capsule flipped over when compared to FIG. 1 and FIG. 2.

FIG. 4A illustrates the brewing capsule shown in FIG. 1 when a first brewing compartment is being used to brew a beverage.

FIG. 4B illustrates the brewing capsule shown in FIG. 1 when a second brewing compartment is being used to brew a beverage.

FIG. 5 illustrates a perspective view of another embodiment of a brewing capsule.

FIG. 6 illustrates a cross sectional view of the brewing capsule shown in FIG. 5.

FIG. 7 illustrates a cut and perspective view of the brewing capsule flipped over when compared to FIG. 5 and FIG. 6.

FIG. 8A illustrates the brewing capsule shown in FIG. 1 when a first brewing compartment is being used to brew a beverage.

FIG. 8B illustrates the brewing capsule shown in FIG. 1 when a second brewing compartment is being used to brew a beverage.

FIG. 9 illustrates a top view of the brewing capsule in order to illustrate a horizontal offset.

FIG. 10 illustrates a perspective view of yet another embodiment of a brewing capsule.

FIG. 11 illustrates an exterior view of the brewing capsule shown in FIG. 10.

FIG. 12 illustrates a cross sectional view of the brewing capsule shown in FIG. 10.

FIG. 13 illustrates another cross sectional view of the brewing capsule shown in FIG. 10.

FIG. 14 illustrates one embodiment of a nozzle that may be utilized on an inlet brewing needle when brewing a beverage with the brewing capsule shown in FIG. 10, FIG. 11, FIG. 12, and FIG. 13.

### DETAILED DESCRIPTION

The embodiments set forth below represent the necessary information to enable those skilled in the art to practice the disclosure and illustrate the best mode of practicing the disclosure. Upon reading the following description in light of the accompanying drawings, those skilled in the art will understand the concepts of the disclosure and will recognize applications of these concepts not particularly addressed herein. It should be understood that these concepts and applications fall within the scope of the disclosure and the accompanying claims.

Throughout this disclosure, relative terminology, such as “approximately,” “substantially,” “proximate,” “near” and the like, may be used in a predicate to describe features and relationships between features of a device or method. The relative terminology in the predicate should be interpreted sensu lato. However, whether the predicate employing the relative terminology is satisfied is determined in accordance to error ranges and/or variation tolerances that are relevant to the predicate and allow the feature or related features described by the predicate to perform their intended function.

It should be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

This disclosure relates generally to brewing capsules for brewing machines. More specifically, the brewing capsules have been designed to include multiple brewing compartments so that the brewing capsule can be used more than once. While the specific embodiments shown herein show only two brewing compartments, the techniques and methods described herein can be utilized to create brewing capsules with more than one brewing compartment. Different techniques for dealing with the problems of creating these capsules are solved in this disclosure, including the placement and arrangement of receptacle dividers so that the receptacle dividers work with and do not interfere with either an inlet brewing needle or an outlet brewing needle of the brewing machine.

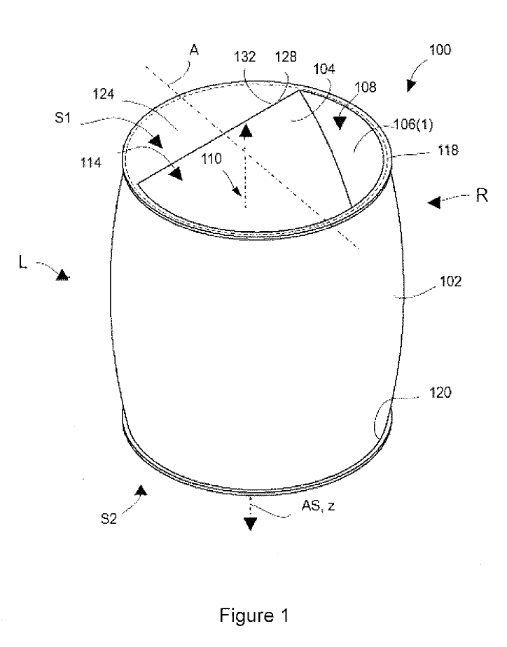

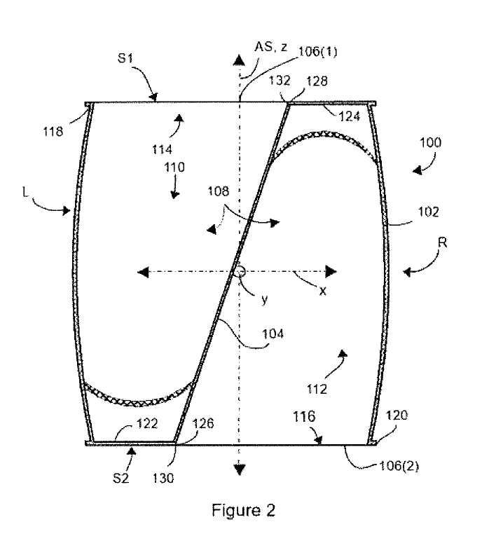

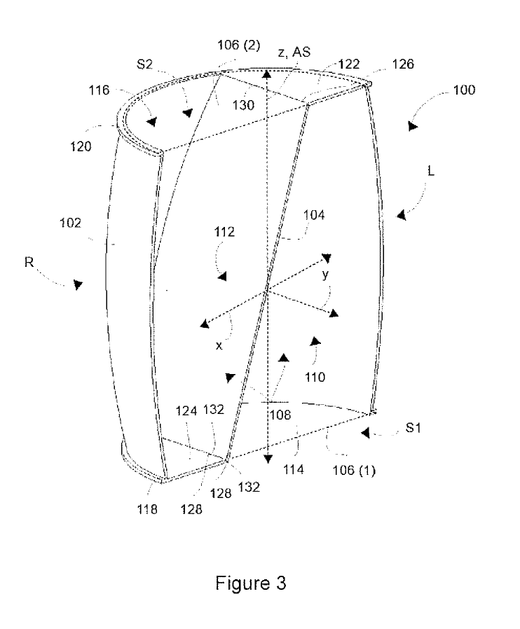

Referring now to FIG. 1, FIG. 2, and FIG. 3, FIG. 1 illustrates a perspective view of one embodiment of a brewing capsule 100, FIG. 2 illustrates a cross sectional view of the brewing capsule 100 cut along line A (shown in FIG. 1), and FIG. 3 illustrates a cut and perspective view of the brewing capsule 100 flipped over when compared to FIG. 1 and FIG. 2. The brewing capsule 100 includes a capsule brewing receptacle 102, a receptacle divider 104, a capsule cover 106(1) (shown as transparent so that other structures of the brewing capsule 100 are easily perceivable), and a capsule cover 106(2) (shown as transparent so that other structures of the brewing capsule 100 are easily perceivable). The capsule brewing receptacle 102 defines a receptacle brewing cavity 108 for receiving organic material to brew a beverage. For example, the capsule brewing receptacle 102 may be used to brew coffee, tea, hot chocolate, and medicines (e.g., Emergen-C or Theraflu).

As shown in FIG. 1, FIG. 2, and FIG. 3, the receptacle divider 104 is configured to divide the receptacle brewing cavity 108 into a first brewing compartment 110 and a second brewing compartment 112. More specifically, the first brewing compartment 110 and the second brewing compartment 112 are partitioned by the receptacle divider 104 such that the first brewing compartment 110 and the second brewing compartment 112 are entirely segregated from one another in the receptacle brewing cavity 108. In this manner, organic brewing material may be provided in each of the brewing compartments 110, 112 so that the brewing capsule 100 can be used to brew a beverage twice. While this embodiment of the brewing capsule 100 includes two of the brewing compartments 110, 112, other embodiments of the brewing capsule 100 may include any number of brewing compartments depending on the configuration of one or more dividers provided within the receptacle brewing cavity 108.

In this embodiment, the capsule brewing receptacle 102 defines a receptacle opening 114 that leads into the first brewing compartment 110 and a receptacle opening 116 that leads into the second brewing compartment 112. Thus, organic brewing material can be placed in each of the brewing compartments 110, 112 through their respective receptacle openings 114, 116. The receptacle divider 104 separates and segregates each of the brewing compartments 110, 112 so that the brewing capsule 100 can be used twice to brew a beverage, once for each of the brewing compartments 110, 112.

The receptacle openings 114, 116 are vertically oppositely disposed to one another. More specifically, the capsule brewing receptacle 102 defines an axis of symmetry AS, which defines the vertical axis z with respect to the brewing capsule 100 itself. Horizontal axes x and y can be defined as orthogonal to the z-axis and orthogonal to one another. As shown in FIG. 1, FIG. 2, and FIG. 3, the receptacle openings 114, 116 are on opposite vertical sides S1, S2 of the brewing capsule 100. The brewing capsule 100 is arranged so that the brewing capsule 100 can be used to brew once with the vertical side S1 facing upwards. In this case, the first brewing compartment 110 would be used to brew the beverage. Subsequently, the brewing capsule 100 can be flipped 180 degrees with respect to the y-axis and be used again to brew a beverage. In this case, the second brewing compartment 112 would be used to brew a beverage.

In this example, the capsule brewing receptacle 102 has a circular cross-section through the vertical range of the brewing capsule 100. However, it should be noted that the capsule brewing receptacle 102 may be of any suitable shape, which may at least partially depend on the particular brewing machine that the brewing capsule 100 is to be placed in to brew the beverage. In this embodiment, the capsule brewing receptacle 102 has an outer rim 118 that defines the receptacle opening 114 and an outer rim 120 that defines the receptacle opening 116. Both the outer rim 118 and the outer rim 120 are provided so that each defines a perimeter of an internal area, which in this example is circular. The outer rim 118 and the outer rim 120 are vertically oppositely disposed with respect to one another since the outer rim 118 is on the vertical side S1 of the brewing capsule 100 while the outer rim 120 is on the vertical side S2 of the brewing capsule 100.

The first brewing compartment 110 has a receptacle bottom 122 that is on the vertical side S2 of the brewing capsule 100 while the second brewing compartment 112 has a receptacle bottom 124 that is on the vertical side S1 of the brewing capsule 100.

In this case, the receptacle bottom 122 of the first brewing compartment 110 is a bottom panel that is connected to the outer rim 120 and extends into the internal area that is surrounded by the outer rim 120 (See FIG. 3). The outer rim 120 also defines the receptacle opening 116 to the second brewing compartment 112. The internal area of the outer rim 120 thus provides the receptacle bottom 122 of the first brewing compartment 110 and the receptacle opening 116 of the second brewing compartment 112. Thus, the receptacle bottom 122 of the first brewing compartment 110 is vertically aligned with receptacle opening 116.

Furthermore, the receptacle bottom 124 of the second brewing compartment 112 is a bottom panel that is connected to the outer rim 118 and extends into the internal area that is surrounded by the outer rim 118 (See FIG. 1). The outer rim 118 also defines the receptacle opening 114 to the first brewing compartment 110. The internal area of the outer rim 118 thus provides the receptacle bottom 124 of the second brewing compartment 112 and the receptacle opening 114 of the first brewing compartment 110. Thus, the receptacle bottom 124 of the second brewing compartment 110 is vertically aligned with receptacle opening 114.

Note that the receptacle bottom 122 and the receptacle bottom 124 do not reach the axis of symmetry AS and thus the majority of the internal area of the outer rim 118 and the majority of the internal area of the outer rim 120 is taken up by the receptacle openings 114, 116 and not the receptacle bottoms 124, 122. Furthermore, the receptacle bottom 122 and the receptacle bottom 124 are horizontally oppositely disposed. In this example, the capsule brewing receptacle 102 has a horizontal side L that is opposite the horizontal side R with respect to the axis of symmetry AS. The receptacle bottom 122 is on side L while the receptacle bottom 124 is on side R.

As shown in FIG. 1, FIG. 2, and FIG. 3, the receptacle divider 104 is a receptacle panel that is coupled to the outer rim 120 and the outer rim 122 in order to define the first brewing compartment 110 and the second brewing compartment 112. The receptacle divider 104 defines a panel edge 126 and a panel edge 128 oppositely disposed to the panel edge 126. Additionally, the receptacle bottom 122 defines an outer edge 130 that is unconnected to the outer rim 120 while the receptacle bottom 124 defines an outer edge 132 that is unconnected to the outer rim 118. Instead, the panel edge 126 is connected to the outer edge 130 while the panel edge 128 is connected to the outer edge 132. Since receptacle bottoms 122, 124 are on the opposite horizontal sides L, R and neither of the receptacle bottoms 122, 124 extends far enough to reach the axis of symmetry AS, the receptacle divider 104 is slanted between the receptacle opening 114 and receptacle opening 116. This slant in the receptacle divider 104 allows for an inlet brewing needle of a brewing machine to be inserted into the first beverage compartment 110 and into the second beverage compartment 112 without piercing the receptacle divider 104.

Furthermore, the receptacle bottom 122, the receptacle bottom 124, and the receptacle divider 104 are arranged such that the brewing capsule 100 has rotational symmetry. In this embodiment, the receptacle divider 104 is arranged so that the first brewing compartment 110 and the second brewing compartment 112 are substantially equal in volume. The outer rims 118, 120 are the same size, the receptacle bottoms 122, 124 are the same size, and receptacle openings 114, 116 are the same size. Additionally, the outer rims 118, 120 are directly vertically aligned.

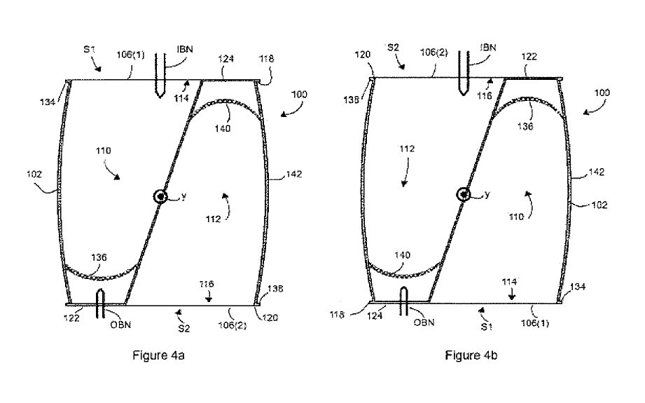

FIG. 4A and FIG. 4B illustrate the rotational symmetry of the brewing capsule 100. FIG. 4A illustrates the brewing capsule 100 while the first brewing compartment 110 is being used to brew a beverage. The outer rim 118 has a sealing ridge 134 that extends out away from the axis of symmetry AS. The brewing capsule 100 includes the capsule cover 106(1) that covers the receptacle opening 114 and the receptacle bottom 124. In one example, the capsule cover 106(1) is a foil cover that is attached to the sealing ridge 134. As shown in FIG. 4A, the capsule cover 106(1) is pierceable by the inlet brewing needle IBN of a brewing machine. The slant in the receptacle divider 104 allows for the inlet brewing needle IBN to pierce into the first brewing compartment 110 without piercing the receptacle divider 104. The slant in the receptacle divider 104 should be selected based on the configuration of the inlet brewing needle IBN and the brewing machine. The arrangement also allows for the outlet brewing needle OBN to pierce through the receptacle bottom 122.

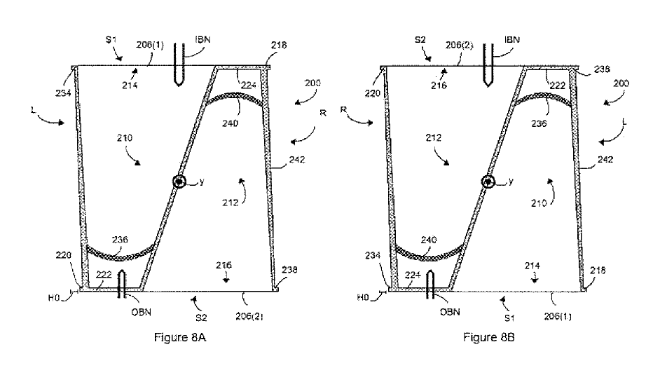

As shown, the first brewing compartment 110 includes a filter brewing sheet 136 that extends across the first brewing compartment 110 close to the receptacle bottom 122. Organic brewing material can be provided in the first brewing compartment 110 over this filter brewing sheet 136 so that hot water from the inlet brewing needle IBN brews the beverage and filters through the filter brewing sheet 136 into the outlet brewing needle OBN. The arrangement provides rotational symmetry since the brewing capsule 100 appears the same if the brewing capsule 100 is rotated 180 degrees with respect to the y axis (coming out of the page in FIG. 8A and FIG. 8B).

FIG. 4B illustrates the brewing capsule 100 while the second brewing compartment 112 is being used to brew a beverage. The outer rim 120 has a sealing ridge 138 that extends out away from the axis of symmetry AS. The brewing capsule 100 includes the capsule cover 106(2) that covers the receptacle opening 116 and the receptacle bottom 122. In one example, the capsule cover 106(2) is a foil cover that is attached to the sealing ridge 138. As shown in FIG. 4B, the capsule cover 106(2) is pierceable by the inlet brewing needle IBN of the brewing machine. The slant in the receptacle divider 104 allows for the inlet brewing needle IBN to pierce into the second brewing compartment 112 without piercing the receptacle divider 104. Furthermore, the arrangement allows for the outlet brewing needle OBN to pierce through the receptacle bottom 124. As shown, the second brewing compartment 112 includes a filter brewing sheet 140 that extends across the second brewing compartment 112 close to the receptacle bottom 122. Organic brewing material can be provided in the second brewing compartment 112 over this filter brewing sheet 140 so that hot water from the inlet brewing needle IBN brews the beverage and filters through the filter brewing sheet 140 into the outlet brewing needle OBN. As such, the beverage capsule 100 can be used to brew a beverage twice by flipping the beverage capsule 100 180 degrees with respect to the y-axis.

In this example, the capsule brewing receptacle 102 is formed with an outer panel 142. As shown in FIG. 4A and FIG. 4B, the outer panel 142 is configured so that the capsule brewing receptacle 102 has a variable cross sectional area such that the variable cross sectional area is at a maximum approximately at a middle cross section of the capsule brewing receptacle 102. In this manner, the capsule brewing receptacle 102 is arranged so as to fit into a brewing machine that brews k-cup capsules since these typically have a top opening that has a diameter that is larger than the diameter of the receptacle bottom. The arrangement allows either vertical side S1, S2 to be at the bottom of the housing used in the brewing machine for the brewing capsule 100 while still fitting snuggly since the outer panel 142 bulges out. The capsule brewing receptacle 102 and receptacle divider 104 may be made out of any suitable material such as polypropylene and/or polystyrene. The capsule covers 106(1), 106(2) may be formed from any suitable material such as a flexible metal, like aluminum. The receptacle divider 104, the outer panel 142, and the receptacle bottoms 122, 124 may be provided as one integrated piece to eliminate the risk of separation during brewing.

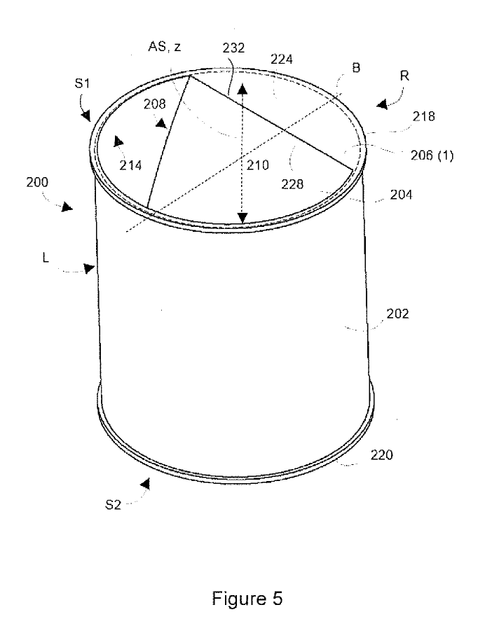

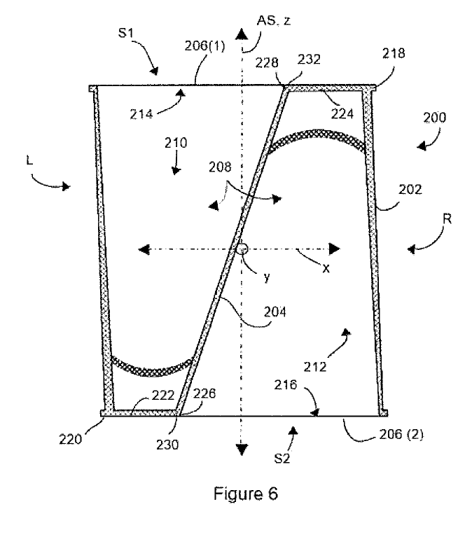

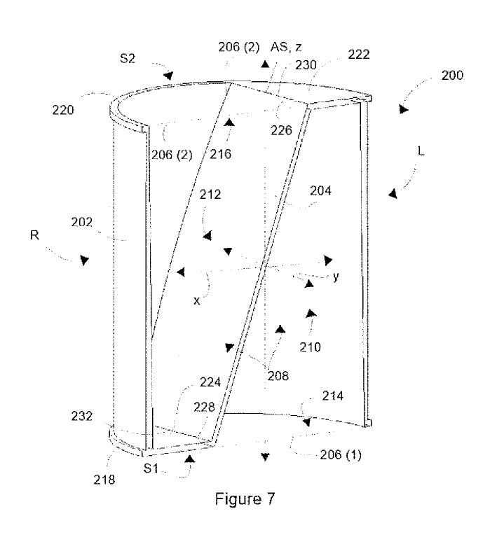

Referring now to FIG. 5, FIG. 6, and FIG. 7, FIG. 5 illustrates a perspective view of another embodiment of a brewing capsule 200, FIG. 6 illustrates a cross sectional view of the brewing capsule 200 cut along line B (shown in FIG. 5), and FIG. 7 illustrates a cut and perspective view of the brewing capsule 200 flipped over when compared to FIG. 5 and FIG. 6. The brewing capsule 200 includes a capsule brewing receptacle 202, a receptacle divider 204, a capsule cover 206(1) (shown as transparent so that other structures of the brewing capsule 200 are easily perceivable), and a capsule cover 206(2) (shown as transparent so that other structures of the brewing capsule 200 are easily perceivable). The capsule brewing receptacle 202 defines a receptacle brewing cavity 208 for receiving organic material to brew a beverage. For example, the capsule brewing receptacle 202 may be used to brew coffee, tea, hot chocolate, and medicines (e.g., Emergen-C or Theraflu).

As shown in FIG. 5, FIG. 6, and FIG. 7, the receptacle divider 204 is configured to divide the receptacle brewing cavity 208 into a first brewing compartment 210 and a second brewing compartment 212. More specifically, the first brewing compartment 210 and the second brewing compartment 212 are partitioned by the receptacle divider 204 such that the first brewing compartment 210 and the second brewing compartment 212 are entirely segregated from one another in the receptacle brewing cavity 208. In this manner, organic brewing material may be provided in each of the brewing compartments 210, 212 so that the brewing capsule 200 can be used to brew a beverage twice. While this embodiment of the brewing capsule 200 includes two of the brewing compartments 210, 212, other embodiments of the brewing capsule 200 may include any number of brewing compartments depending on the configuration of one or more dividers provided within the receptacle brewing cavity 208.

In this embodiment, the capsule brewing receptacle 202 defines a receptacle opening 214 that leads into the first brewing compartment 210 and a receptacle opening 216 that leads into the second brewing compartment 212. Thus, organic brewing material can be placed in each of the brewing compartments 210, 212 through their respective receptacle opening 214, 216. The receptacle divider 204 separates and segregates each of the brewing compartments 210, 212 so that the brewing capsule 200 can be used twice to brew a beverage, once for each of the brewing compartments 210, 212.

The receptacle openings 214, 216 are vertically oppositely disposed to one another. More specifically, the capsule brewing receptacle 202 defines an axis of symmetry AS, which defines the vertical axis z with respect to the brewing capsule 200 itself. Horizontal axes x and y can be defined as orthogonal to the z-axis and orthogonal to one another. As shown in FIG. 5, FIG. 6, and FIG. 7, the receptacle openings 214, 216 are on opposite vertical sides S1, S2 of the brewing capsule 200. The brewing capsule 200 is arranged so that the brewing capsule 200 can be used to brew once with the vertical side S1 facing upwards. In this case, the first brewing compartment 210 would be used to brew the beverage. Subsequently, the brewing capsule 200 can be flipped 180 degrees with respect to the y-axis and be used again to brew a beverage. In this case, the second brewing compartment 212 would be used to brew a beverage.

In this example, the capsule brewing receptacle 202 has a circular cross-section through the vertical range of the brewing capsule 200. However, it should be noted that the capsule brewing receptacle 202 may be of any suitable shape, which may at least partially depend on the particular brewing machine that the brewing capsule 200 is to be placed in to brew the beverage. In this embodiment, the capsule brewing receptacle 202 has an outer rim 218 that defines the receptacle opening 214 and an outer rim 220 that defines the receptacle opening 216. Both the outer rim 218 and the outer rim 220 are provided so that each defines a perimeter of an internal area, which in this example is circular. The outer rim 218 and the outer rim 220 are vertically oppositely disposed with respect to one another since the outer rim 218 is on the vertical side S1 of the brewing capsule 200 while the outer rim 220 is on the vertical side S2 of the brewing capsule 200.

The first brewing compartment 210 has a receptacle bottom 222 that is on the vertical side S2 of the brewing capsule 200 while the second brewing compartment 212 has a receptacle bottom 224 that is on the vertical side S1 of the brewing capsule 200.

In this case, the receptacle bottom 222 of the first brewing compartment 210 is a bottom panel that is connected to the outer rim 220 and extends into the internal area that is surrounded by the outer rim 220 (See FIG. 7). The outer rim 220 also defines the receptacle opening 216 to the second brewing compartment 212. The internal area of the outer rim 220 thus provides the receptacle bottom 222 of the first brewing compartment 210 and the receptacle opening 216 of the second brewing compartment 212. Thus, the receptacle bottom 222 of the first brewing compartment 210 is vertically aligned with receptacle opening 216.

Furthermore, the receptacle bottom 224 of the second brewing compartment 212 is a bottom panel that is connected to the outer rim 218 and extends into the internal area that is surrounded by the outer rim 218 (See FIG. 5). The outer rim 218 also defines the receptacle opening 214 to the first brewing compartment 210. The internal area of the outer rim 218 thus provides the receptacle bottom 224 of the second brewing compartment 212 and the receptacle opening 214 of the first brewing compartment 210. Thus, the receptacle bottom 224 of the second brewing compartment 210 is vertically aligned with receptacle opening 214.

Note that the receptacle bottom 222 and the receptacle bottom 224 do not reach the axis of symmetry AS and thus the majority of the internal area of the outer rim 218 and the majority of the internal area of the outer rim 220 is taken up by the receptacle openings 214, 216 and not the receptacle bottoms 224, 222. Furthermore, the receptacle bottom 222 and the receptacle bottom 224 are horizontally oppositely disposed. In this example, the capsule brewing receptacle 202 has a horizontal side L that is opposite the horizontal side R with respect to the axis of symmetry AS. The receptacle bottom 222 is on side L while the receptacle bottom 224 is on side R.

As shown in FIG. 5, FIG. 6, and FIG. 7, the receptacle divider 204 is a receptacle panel that is coupled to the outer rim 220 and the outer rim 222 in order to define the first brewing compartment 210 and the second brewing compartment 212. The receptacle divider 204 defines a panel edge 226 and a panel edge 228 oppositely disposed to the panel edge 226. Additionally, the receptacle bottom 222 defines an outer edge 230 that is unconnected to the outer rim 220 while the receptacle bottom 224 defines an outer edge 232 that is unconnected to the outer rim 218. Instead, the panel edge 226 is connected to the outer edge 230 while the panel edge 228 is connected to the outer edge 232. Since receptacle bottoms 222, 224 are on the opposite horizontal sides L, R and neither of the receptacle bottoms 222, 224 extends far enough to reach the axis of symmetry AS, the receptacle divider 204 is slanted between the receptacle opening 214 and receptacle opening 216. This slant in the receptacle divider 204 allows for an inlet brewing needle of the brewing machine to be inserted into the first beverage compartment 210 and into the second beverage compartment 212 without piercing the receptacle divider 204.

Furthermore, the receptacle bottom 222, the receptacle bottom 224, and the receptacle divider 204 are arranged such that the brewing capsule 200 has rotational symmetry. In this embodiment, the receptacle divider 204 is arranged so that the first brewing compartment 210 and the second brewing compartment 212 are substantially equal in volume. The outer rims 218, 220 are the same size, the receptacle bottoms 222, 224 are the same size, and receptacle openings 214, 216 are the same size. However, as explained in further detail below, the outer rims 218, 220 are not directly vertically aligned, unlike the embodiment shown in FIG. 1, FIG. 2, FIG. 3, FIG. 4A, and FIG. 4B.

FIG. 8A and FIG. 8B illustrate the rotational symmetry of the brewing capsule 200. FIG. 8A illustrates the brewing capsule 200 while the first brewing compartment 210 is being used to brew a beverage. The outer rim 218 has a sealing ridge 234 that extends out away from the axis of symmetry AS. The brewing capsule 200 includes the capsule cover 206(1) that covers the receptacle opening 214 and the receptacle bottom 224. In one example, the capsule cover 206(1) is a foil cover that is attached to the sealing ridge 234. As shown in FIG. 8A, the capsule cover 206(1) is pierceable by the inlet brewing needle IBN of a brewing machine. The slant in the receptacle divider 204 allows for the inlet brewing needle IBN to pierce into the first brewing compartment 210 without piercing the receptacle divider 204. As such, the slant in the receptacle divider 204 should be selected based on the configuration of the inlet brewing needle IBN and the brewing machine. Furthermore, the arrangement allows for the outlet brewing needle OBN to pierce through the receptacle bottom 222. As shown, the first brewing compartment 210 includes a filter brewing sheet 236 that extends across the first brewing compartment 210 close to the receptacle bottom 222. Organic brewing material can be provided in the first brewing compartment 210 over this filter brewing sheet 236 so that hot water from the inlet brewing needle IBN brews the beverage and filters through the filter brewing sheet 236 into the outlet brewing needle OBN. The arrangement provides rotational symmetry since the brewing capsule 200 appears the same if the brewing capsule 200 is rotated 180 degrees with respect to the y axis (coming out of the page).

FIG. 8B illustrates the brewing capsule 200 while the second brewing compartment 212 is being used to brew a beverage. The outer rim 220 has a sealing ridge 238 that extends out away from the axis of symmetry AS. The brewing capsule 200 includes the capsule cover 206(2) that covers the receptacle opening 216 and the receptacle bottom 222. In one example, the capsule cover 206(2) is a foil cover that is attached to the sealing ridge 238. As shown in FIG. 8B, the capsule cover 206(2) is pierceable by the inlet brewing needle IBN of the brewing machine. As such, the slant in the receptacle divider 204 allows for the inlet brewing needle IBN to pierce into the second brewing compartment 212 without piercing the receptacle divider 204. Furthermore, the arrangement allows for the outlet brewing needle OBN to pierce through the receptacle bottom 224. As shown, the second brewing compartment 212 includes a filter brewing sheet 240 that extends across the second brewing compartment 212 close to the receptacle bottom 222. Organic brewing material can be provided in the second brewing compartment 212 over this filter brewing sheet 240 so that hot water from the inlet brewing needle IBN brews the beverage and filters through the filter brewing sheet 240 into the outlet brewing needle OBN. As such, the beverage. capsule 200 can be used to brew a beverage twice by flipping the beverage capsule 200 180 degrees with respect to the y-axis.

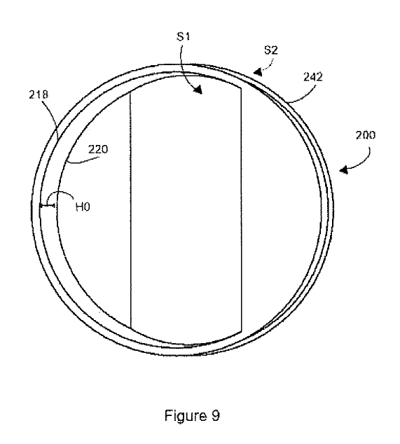

Referring now to FIG. 8A, FIG. 8B, and FIG. 9, the outer rims 218, 220 of the brewing capsule 200 are not directly vertically aligned but instead have a horizontal offset HO. FIG. 9 illustrates a top view of the brewing capsule 200 from either the vertical side S1 or the vertical side S2 (both views are the same due to the rotational symmetry discussed above). In this embodiment, the capsule brewing receptacle 202 has an outer panel 242 that defines the receptacle brewing cavity 242. The horizontal offset HO allow for manufacturing by injection molding since the draft angle is needed to remove the tooling that performs the injection molding. As shown in FIG. 9, the horizontal offset HO between the outer rim 218 and the outer rim 220 creates a draft angle in the outer panel 242. Thus, as is shown in FIG. 8A and in FIG. 8B, this results in the thickness of the outer panel 242 to taper from smaller to larger from the receptacle opening 214 to the receptacle bottom 222 and to taper from smaller to larger from the receptacle opening 216 to the receptacle bottom 224.

The horizontal offset HO allows the brewing capsule 200 to fit into a brewing machine that brews k-cup capsules since these typically have a top opening with a diameter that is larger than the diameter of the receptacle bottom. The arrangement allows either vertical side S1, S2 to be at the bottom of the housing used in the brewing machine for the brewing capsule 200 while still fitting snuggly since the outer panel 242 provides the horizontal offset HO to make up for the distance required by the larger top opening used in the k-cup. The capsule brewing receptacle 202 and receptacle divider 204 may be made out of any suitable material such as polypropylene and/or polystyrene. The capsule covers 206(1), 206(2) may be formed from any suitable material such as a flexible metal, like aluminum. The receptacle divider 204, the outer panel 242, and the receptacle bottoms 222, 224 may be provided as one integrated piece to eliminate the risk of separation during brewing.

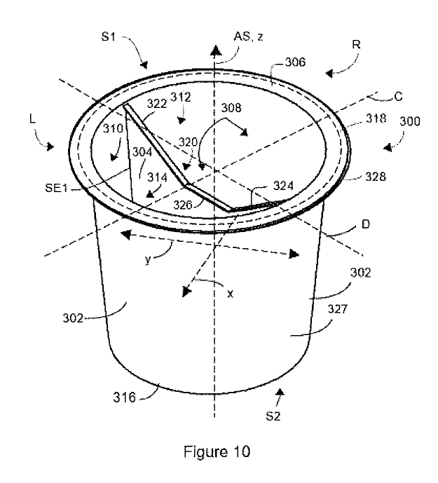

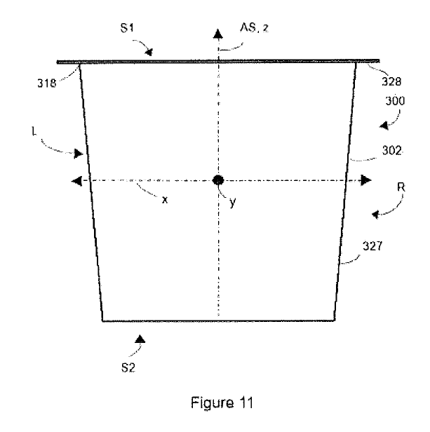

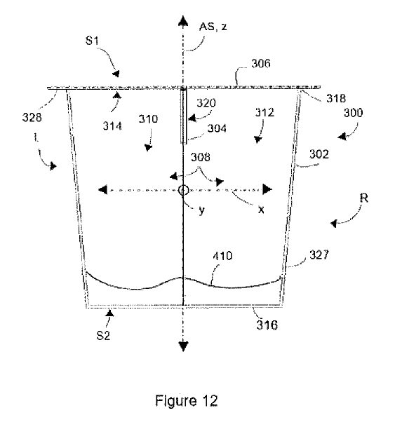

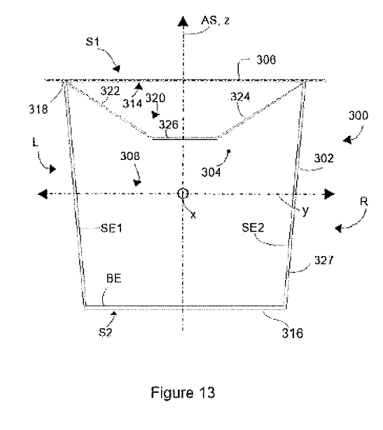

Referring now to FIG. 10, FIG. 11, FIG. 12, and FIG. 13, FIG. 10 illustrates a perspective view of another embodiment of a brewing capsule 300, FIG. 11 illustrates an exterior view of the brewing capsule 300, FIG. 12 illustrates a cross sectional view of the brewing capsule 300 cut along line C (shown in FIG. 10), and FIG. 13 illustrates a cross sectional view of the brewing capsule 300 cut along line D (shown in FIG. 10). The brewing capsule 300 includes a capsule brewing receptacle 302, a receptacle divider 304, and a capsule cover 306 (shown as transparent so that other structures of the brewing capsule 300 are easily perceivable). The capsule brewing receptacle 302 defines a receptacle brewing cavity 308 for receiving organic material to brew a beverage. For example, the capsule brewing receptacle 302 may be used to brew coffee, tea, hot chocolate, and medicines (e.g., Emergen-C or Theraflu).

As shown in FIG. 10, FIG. 11, FIG. 12, and FIG. 13, the receptacle divider 304 is configured to divide the receptacle brewing cavity 308 into a first brewing compartment 310 and a second brewing compartment 312. More specifically, the first brewing compartment 310 and the second brewing compartment 312 are partitioned by the receptacle divider 304 such that the first brewing compartment 310 and the second brewing compartment 312 are entirely segregated from one another in the receptacle brewing cavity 308. In this manner, organic brewing material may be provided in each of the brewing compartments 310, 312 so that the brewing capsule 300 can be used to brew a beverage twice. While this embodiment of the brewing capsule 300 includes two of the brewing compartments 310, 312, other embodiments of the brewing capsule 300 may include any number of brewing compartments depending on the configuration of one or more dividers provided within the receptacle brewing cavity 308.

In this embodiment, the capsule brewing receptacle 302 defines a receptacle opening 314 that leads into the first brewing compartment 310 and the second brewing compartment 312. The capsule brewing receptacle 302 also includes a receptacle bottom 316, which in this embodiment forms the bottom of both the first brewing compartment 310 and the second brewing compartment 312. Organic brewing material can be placed in each of the brewing compartments 310, 312 through the receptacle opening 314. The receptacle divider 304 separates and segregates each of the brewing compartments 310, 312 so that the brewing capsule 300 can be used twice to brew a beverage, once for each of the brewing compartments 310, 312.

The receptacle opening 314 and the receptacle bottom 316 are vertically oppositely disposed to one another. More specifically, the capsule brewing receptacle 302 defines an axis of symmetry AS, which defines the vertical axis z with respect to the brewing capsule 300 itself. Horizontal axes x and y can be defined as orthogonal to the z-axis and orthogonal to one another. As shown in FIG. 10, FIG. 11, FIG. 12, and FIG. 13, the receptacle opening 314 and the receptacle bottom 316 are on opposite vertical sides S1, S2 of the brewing capsule 300. In this example, the receptacle bottom 316 is a bottom panel.

In this example, the capsule brewing receptacle 302 has a circular cross-section through the vertical range of the brewing capsule 300. However, it should be noted that the capsule brewing receptacle 302 may be of any suitable shape, which may at least partially depend on the particular brewing machine that the brewing capsule 300 is to be place in to brew the beverage. In this embodiment, the capsule brewing receptacle 302 has an outer rim 318 that defines the receptacle opening 314. The outer rim 318 defines a perimeter of an internal area, which in this example is circular. The outer rim 318 and the receptacle bottom 316 are vertically oppositely disposed with respect to one another since the outer rim 318 is on the vertical side S1 of the brewing capsule 300 while the receptacle bottom 316 is on the vertical side S2 of the brewing capsule 300.

As shown in FIG. 10, FIG. 11, FIG. 12, and FIG. 13, the receptacle bottom 316 of the capsule brewing receptacle 302 has an internal area that is smaller than the internal area of the outer rim 318. In this embodiment, the internal area of the outer rim 318 is taken up entirely by the receptacle opening 314 and thus the receptacle opening 314 is circular.

In this example, the capsule brewing receptacle 302 has a horizontal side L that is opposite the horizontal side R with respect to the axis of symmetry AS. The first receptacle compartment 310 is on side L while the second receptacle compartment 312 is on side R. In this example, the receptacle divider 304 divides the receptacle brewing cavity 308 into halves on each horizontal side L, R so as to create the first brewing compartment 310 and the second brewing compartment 312. The receptacle divider 304 is a receptacle panel that is oriented so as to be substantially parallel to the axis of symmetry AS. In this embodiment, the receptacle divider 304 furthermore divides the receptacle brewing cavity 308 into the first brewing compartment 310 and the second brewing compartment 312 such that the first brewing compartment 310 and the second brewing compartment 312 are substantially equal in volume. Thus, unlike the brewing capsules 100, 200, the receptacle divider 304 of the brewing capsule 300 is not slanted.

Instead, to prevent the receptacle divider 304 from interfering with the inlet brewing needle, the receptacle divider 304 defines a top panel edge that defines a vertical dip 320 below the receptacle opening 314 that leads into the first receptacle compartment 310 on side L and the second receptacle compartment 312 on side R. The vertical dip 320 should have a maximum depth large enough to prevent the receptacle divider 304 from hitting the inlet brewing needle and a nozzle (explained in further detail below) when the beverage is being brewed. The vertical dip 320 creates this depth by defining a first edge section 322, a second edge section 324, and a third edge section 326. The first edge section 322 and the second edge section 324 slope downward between the outer rim 318 and the third edge section 326 with respect to the axis of symmetry. The third edge section 326 is approximately crosses the axis of symmetry AS, and, in this example, is orthogonal to the axis of symmetry AS along the y axis.

The brewing capsule 300 includes an outer panel 327 that defines the receptacle brewing cavity 308. In this embodiment, both side edges SE1, SE2 of the receptacle divider 304 are connected to an interior surface of the outer panel 327 on the opposite horizontal sides S1, S2. The bottom edge BE of the receptacle divider 304 is connected to the interior surface of the receptacle bottom 316. In this embodiment, the receptacle divider 304, receptacle bottom 316, and outer panel 327 are formed as one integrated piece to eliminate the risk of separation during brewing.

The brewing capsule 300 includes the capsule cover 306 that covers the receptacle opening 314 and the receptacle bottom 316. In one example, the capsule cover 306 is a foil cover that is attached to a sealing ridge 328 of the outer rim 318. The sealing ridge 328 extends from the outer rim 318 and away from the axis of symmetry AS so that the capsule cover 306 can be attached to cover the receptacle opening 314. An inlet brewing needle (e.g., the inlet brewing needle IBN) can pierce through the capsule cover 306 and be unobstructed due to the receptacle divider 304. However, without more, hot water from the inlet brewing needle IBN would simply spill into both the first brewing compartment 310 and the second brewing compartment 312.

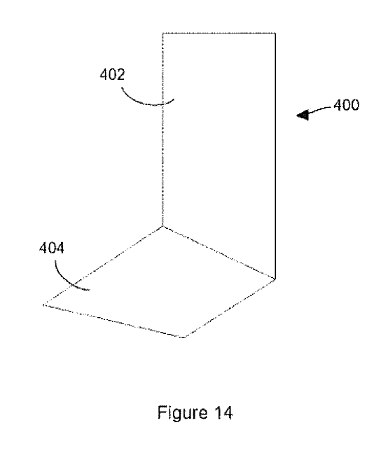

Referring now to FIG. 10, FIG. 11, FIG. 12, FIG. 13, and FIG. 14, FIG. 14 illustrates a nozzle 400 that may be placed over the inlet brewing needle (e.g., inlet brewing needle IBN) to redirect hot water into either the first brewing compartment 310 or the second brewing compartment 312. The nozzle 400 includes a first nozzle section 402 that goes over the inlet brewing needle. A second nozzle section 404 is connected to the first nozzle section 402 and is directed at an angle to redirect the hot water into either the first brewing compartment 310 or the second brewing compartment 312. More specifically, organic brewing material can be provided in the first brewing compartment 310 over a filter sheet 410 (connected across the receptacle brewing cavity 308 near the receptacle bottom 316) so that hot water from the inlet brewing needle spills into the first brewing compartment 310 through the nozzle 400. This brews the beverage that filters through the filter brewing sheet 410 and into an outlet brewing needle (e.g., the outlet brewing needle OBN), which pierces the receptacle bottom 316. The brewing receptacle 300 provides rotational symmetry since the brewing capsule 300 appears the same if the brewing capsule 300 is rotated 180 degrees with respect to the z axis. Thus, by rotating the brewing capsule 180 degrees with respect to the z-axis, the nozzle 400 would redirect the water into the second brewing compartment 312 to brew a second beverage using the organic material in the second brewing compartment 312. In this embodiment, the brewing capsule 300 is designed to fit a brewing machine that brews k-cup capsules where the outer rim 318 has a larger diameter than the receptacle bottom 316. The capsule brewing receptacle 302 and receptacle divider 304 may be made out of any suitable material such as polypropylene and/or polystyrene. In this embodiment, The capsule cover 306 may be formed from any suitable material such as a flexible metal, like aluminum.

Those skilled in the art will recognize improvements and modification to the preferred embodiments of the present disclosure. All such improvements and modifications are considered within the scope of the concepts disclosed herein and the claims that follow.

What is claimed is:

1. A brewing capsule, comprising:
a capsule brewing receptacle defining a receptacle brewing cavity and a first receptacle opening;
a receptacle divider configured to divide the receptacle brewing cavity into a first brewing compartment and a second brewing compartment such that the first brewing compartment and the second brewing compartment are partitioned by the receptacle divider; and
a capsule cover configured to be pierceable by a brewing needle, wherein the capsule cover covers the first receptacle opening.

2. The brewing capsule of claim 1, wherein the first brewing compartment and the second brewing compartment are substantially equal in volume.

3. The brewing capsule of claim 1, wherein the receptacle divider is formed from one or more of a group consisting of polypropylene and polystyrene.

4. The brewing capsule of claim 1, wherein:
the capsule brewing receptacle defines a second receptacle opening opposite the first receptacle opening;
the first receptacle opening opens into the first brewing compartment and the second receptacle opening opens into the second brewing compartment; and
the receptacle divider comprises a receptacle panel, wherein the receptacle panel is slanted between the first receptacle opening and the second receptacle opening.

5. The brewing capsule of claim 4, wherein:
the first brewing compartment defines a first compartment bottom that substantially vertically aligned with the second receptacle opening;
the second brewing compartment defines a second compartment bottom that is substantially vertically aligned with the first receptacle opening.

6. The brewing capsule of claim 1, wherein:
the capsule brewing receptacle defines an axis of symmetry;
the receptacle divider comprises a receptacle panel that is oriented so as to be substantially parallel to the axis of symmetry; and
the receptacle panel defines an edge adjacent to the first receptacle opening, wherein the receptacle panel is configured such that the edge defines a vertical dip below the first receptacle opening.

7. The brewing capsule of claim 6, wherein:
the capsule brewing receptacle comprises an outer rim that defines the first receptacle opening; and
the edge defines the vertical dip such that the vertical dip is vertically below the outer rim.

8. A brewing capsule, comprising:
a capsule brewing receptacle defining a receptacle brewing cavity, wherein the capsule brewing receptacle comprises:
a first outer rim that defines a first receptacle opening;
a second outer rim that defines a second receptacle opening,
wherein the first outer rim and the second outer rim are vertically oppositely disposed with respect to one another; and
a receptacle divider configured to divide the receptacle brewing cavity into a first brewing compartment and a second brewing compartment, wherein the receptacle divider is coupled to the first outer rim and the second outer rim such that the receptacle divider is slanted between the first outer rim and the second outer rim.

9. The brewing capsule of claim 8, wherein the capsule brewing receptacle has a variable cross sectional area such that the variable cross sectional area is at a maximum approximately at a middle cross section of the capsule brewing receptacle.

10. The brewing capsule of claim 8, wherein the capsule brewing receptacle comprises a first bottom panel of the first brewing compartment and a second bottom panel of the second brewing compartment, wherein:
the capsule brewing receptacle defines an axis of symmetry;
the first bottom panel extends from the second outer rim and defines a first outer edge that is unconnected to the second outer rim;
the second bottom panel extends from the first outer rim and defines a second outer edge that is unconnected to the first outer rim; and
the first bottom panel and the second bottom panel are horizontally oppositely disposed with respect to the axis of symmetry.

11. The brewing capsule of claim 10, wherein the receptacle divider comprises a receptacle panel that defines a first panel edge and a second panel edge oppositely disposed to the first panel edge, wherein the first panel edge is connected to the first outer edge of the first bottom panel and the second panel edge is connected to the second outer edge of the second bottom panel.

12. The brewing capsule of claim 11, wherein the first bottom panel, the second bottom panel, and the receptacle panel are arranged such that the brewing capsule has rotational symmetry.

13. The brewing capsule of claim 8, wherein:
the first outer rim and the second outer rim have a horizontal offset; and
the capsule brewing receptacle comprises an outer panel and wherein the horizontal offset between the first outer rim and the second outer rim creates a draft angle in the outer panel.

14. The brewing capsule of claim 8, further comprising:
a first capsule cover attached to the first outer rim so as to cover the first receptacle opening; and
a second capsule cover attached to the second outer rim so as to cover the second receptacle opening.

15. A brewing capsule, comprising:
a capsule brewing receptacle defining a receptacle brewing cavity, a receptacle opening that leads into the receptacle brewing cavity, and a receptacle bottom oppositely disposed to the receptacle opening; and
a receptacle panel that partitions the receptacle brewing cavity into a first brewing compartment and a second brewing compartment, the receptacle panel defining a top panel edge that defines a vertical dip below the first receptacle opening.

16. The brewing capsule of claim 15, wherein:
the brewing capsule further comprises an outer rim that defines the receptacle opening;
the capsule brewing receptacle defines an axis of symmetry; and
the top panel edge having a first edge section, a second edge section, and a third edge section, wherein the first edge section and the second edge section slope downward between the outer rim and the third edge section, wherein the third edge section approximately crosses the axis of symmetry.

17. The brewing capsule of claim 16, wherein the third edge section is substantially horizontal.

18. The brewing capsule of claim 15, wherein the receptacle panel divides the receptacle brewing cavity into the first brewing compartment and the second brewing compartment such that the first brewing compartment and the second brewing compartment are substantially equal in volume.

19. The brewing capsule of claim 15, wherein:
the capsule brewing receptacle defines an axis of symmetry; and
the receptacle panel is oriented so as to be substantially parallel to the axis of symmetry.

20. The brewing capsule of claim 15, further comprising capsule cover that covers the first receptacle opening, wherein the capsule cover is permeable by an inlet brewing needle and wherein the receptacle bottom is permeable by an outlet brewing needle.
